(19) United States
(12) Patent Application Publication
(10) Pub. No.: US 2018/0205301 A1
(43) Pub. Date: Jul. 19, 2018

(54) STACKED TRANSFLUX ELECTRIC MOTOR

(71) Applicant: Ronald J. Didier, Le Mars, IA (US)

(72) Inventor: Ronald J. Didier, Le Mars, IA (US)

(21) Appl. No.: 15/869,631

(22) Filed: Jan. 12, 2018

Related U.S. Application Data
(60) Provisional application No. 62/447,149, filed on Jan. 17, 2017.

(51) Int. Cl. H02K 16/04; H02K 37/04

(52) U.S. Cl. CPC H02K 16/04; H02K 1/148; H02K 37/04

(57) ABSTRACT

A stacked transflux electric motor has a rotor mounted to a rotatable shaft. Enclosing the rotor are a plurality of stators in stacked relation. Each stator has a plurality of spaced alignment teeth that extend inwardly toward the motor. The alignment teeth of one stator are offset with respect to the alignment teeth of an adjacent rotor.

### CROSS REFERENCE TO RELATED APPLICATION

This application claims the benefit of U.S. Provisional Application No. 62/447,149 filed Jan. 17, 2017.

### BACKGROUND OF THE INVENTION

This invention is directed to a transflux electric motor and more particularly to a transflux electric motor having offset stacked stators and rotor cores, one per phase.

Transflux electric motors are well-known in the art and are used to convert electricity to movement by drawing a current from a power source such as a battery to a wire to create a magnetic field. The magnetic field interacts with a nearby ferromagnetic rotor material to create torque by the inductance change as a function of rotor position.

While useful, existing transflux motors have a number of limitations. For example, current motors are less efficient than desired, require many parts, and are expensive to manufacture. In addition, not only is space for the stator winding limited, but because phases are not independent and do not overlap, existing motors are susceptible to torque ripple and noise. Also, as the width of the tooth of a rotor is limited, there is less room for error. Accordingly, a need exists for a motor that addresses these deficiencies.

An objective of the present invention is to provide a stacked transflux electric motor that is more efficient, has fewer parts, and is less expensive.

A further objective of the present invention is to provide a stacked transflux electric motor that has greater space for stator winding that also reduces torque ripple and noise.

A still further objective of the present invention is to provide a stacked transflux electric motor that provides less room for errors.

These and other objectives will become apparent to those having an ordinary skill in the art based upon the following written description, claims and drawings.

### SUMMARY OF THE INVENTION

A stacked transflux electric motor having a rotor mounted to a rotatable shaft. The rotor is enclosed by a plurality of stators in stacked relation. Each stator has an outer shell, a stator core or laminated stack and stator windings. Alternatively, instead of a laminated stack the stator has a filler material such as powdered metal between the outer shell and the inner diameter.

Each stator also has a plurality of inwardly extending alignment teeth. Preferably, when in stacked relation, stators are aligned with respect to each other. Rotors cores are offset. This arrangement in combination with the control creates a flux that occurs sequentially through the length of the stator creating a constant torque at the shaft. In addition, current in the stator windings does not need to change and can flow in a single direction.

### BRIEF DESCRIPTION OF THE DRAWINGS

FIG. 1 is a side view of a rotor;

FIG. 2 is a top plan view of a rotor;

FIG. 3 is a top plan view of a transflux electric motor;

FIG. 4 is a side sectional view of a stator showing flux;

FIG. 5 is a top sectional view of a stacked transflux electric motor; and

FIG. 6 is a side sectional view of a stacked transflux electric motor.

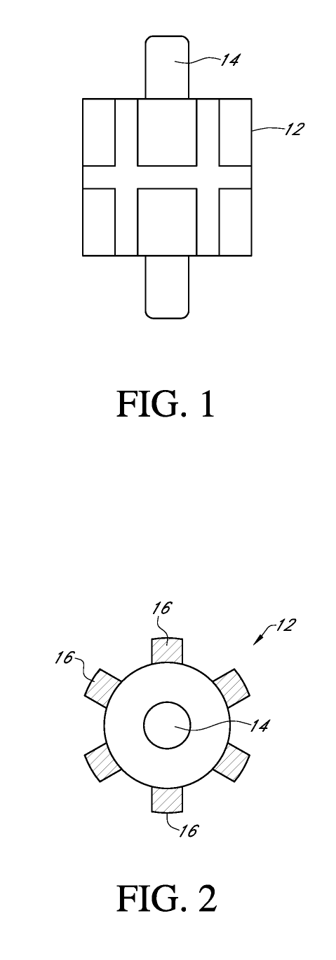

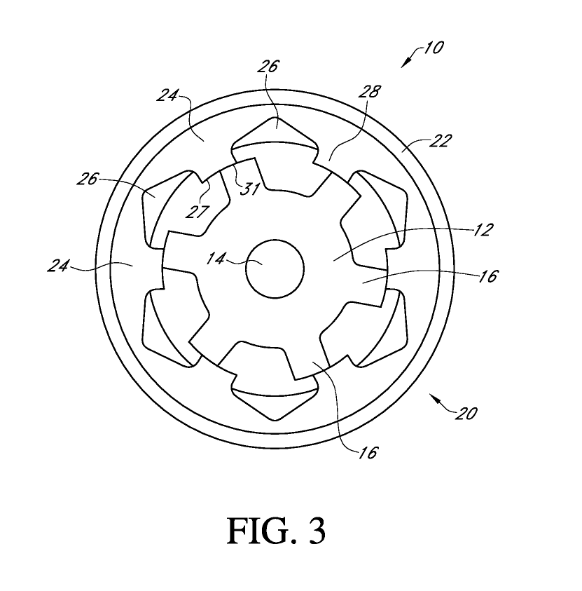

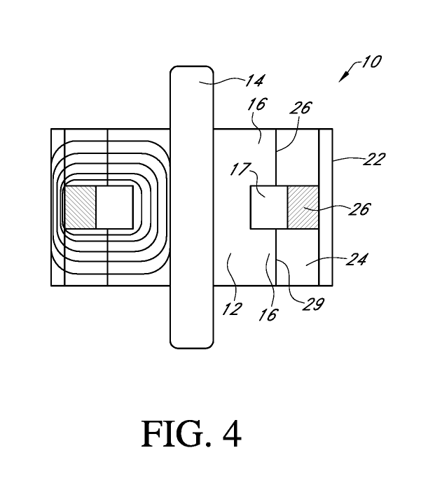

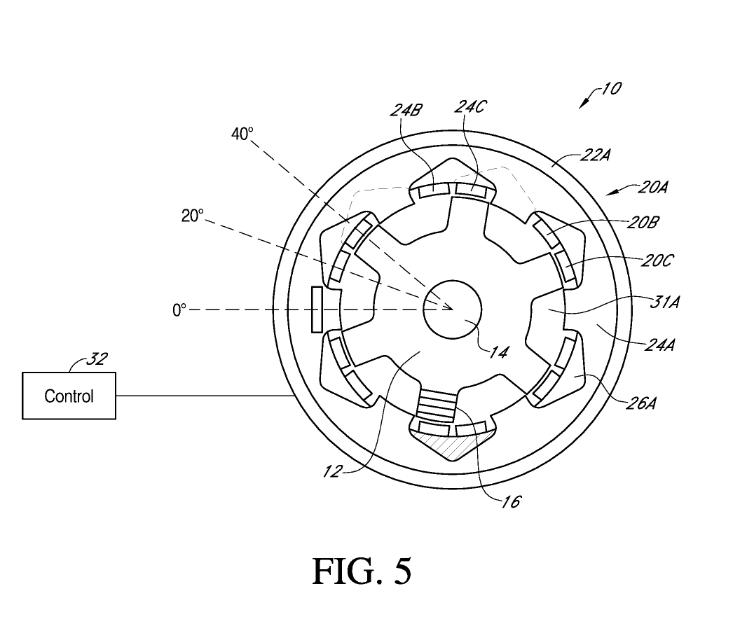

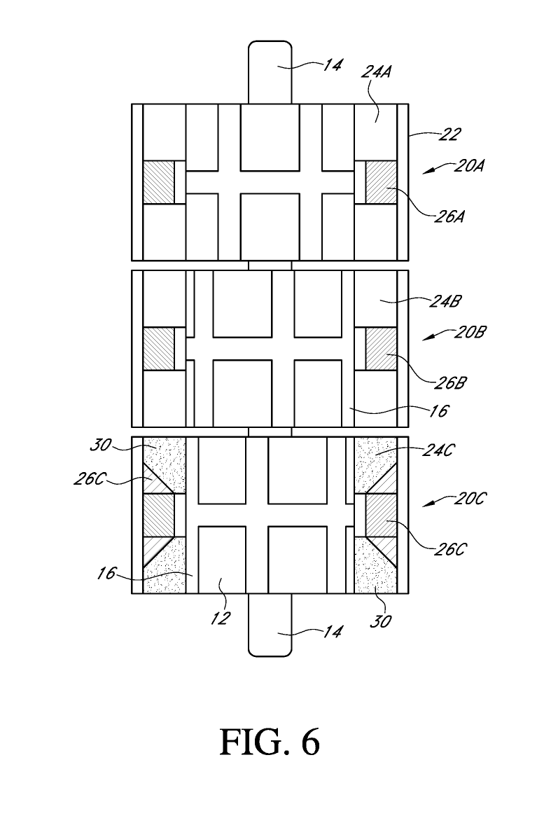

### DETAILED DESCRIPTION

Referring to the Figures, a stacked transflux electric motor 10 has a rotor 12 mounted to a rotatable shaft 14. The rotor 12 is of any size, shape and structure and preferably has a plurality of teeth 16 that extend radially outwardly from the shaft 14. In one example the rotor 12 has six equally spaced teeth. Each tooth 16 has a plurality of U-shaped breakouts 17. The rotor 12 is enclosed by a stator 20 or preferably a plurality of stators 20A, 20B, and 20C in stacked relation to one another. Preferably, each stator has an outer wall or steel shell 22, a stator core 24 or laminated stack and a stator windings or coil 26. The size, shape, and structure of the stator 20 is of any type. The shape of the stator windings 26 is of any type and in one example they are square or rectangular. In another example, the stator winding 26 has a trapezoidal shape which provides more room for the coil winding. Also, instead of the laminated stack between the inner diameter 28 of the stator 20 and the steel shell 22 is a filler material 30 such as powdered metal or the like that is stamped and formed. The inner diameter 27 of the stator 20 has a diameter greater than the outer diameter of the teeth 16 of the rotor 12 that forms an air gap 29.

The size, shape, and structure of the stator stack is of any type. In the example shown, the stator stack has an inwardly extending alignment section 28 or tooth. The alignment section 28 extends inwardly from the stator winding 26 to the inner diameter 27 of the stator 20.

In addition to the stators 20 being in stacked relation, they also are positioned so that the stator teeth 28 of one stator 20 are offset with respect to the stator teeth 28 of an adjacent stator. In a preferred embodiment having three stacked stators 20A, 20B and 20C, with each stator having six equally spaced stator teeth 28, the stator teeth 28 are offset by 20 degrees. For example, stator stack 28A on stator 20A would be positioned at 0 degrees, stator stack 28B on stator 20B would be at a 20 degree position, and stator stack 28C on stator 20C would be at a 40 degree position. This arrangement is repeated around the circumference of the stators every 20 degrees. This offset can occur in either the stator 20 as described or rotor core 12.

In operation, as is known in the art, a control 32 such as a computer having a processor activates a selected stator winding 26. Upon activation, when the stator winding 26 is charged with current, a flux is created in six sections around the shaft 14. More specifically, flux flows around the stator winding 26 from the stator stack 28 above the winding 26 through the air gap 29 to the rotor 12. Along shaft 14 and around the U-shaped breakout 17 to the stator stack 28 below winding 26. Then through the steel shell 22 back to the stator stack above the winding 26. The flux pulls tooth 16 into alignment with alignment section 28 or tooth 16 of the stator stack. Thus, the flux occurs through the length of the stator 20, instead of the rotor, and within the rotor 12 with the coil external to the rotor 12. An adjacent stator winding 26 is then fired by the control 32 pulling the tooth 16 into alignment with alignment section 28. This process is repeated around the stators 20 causing the rotor 12 and shaft 14 to rotate.

This arrangement simplifies the control from a six step control to a three step control. Also, current in the stator windings does not need to change and can flow in a single direction. Each phase is independent and phases can overlap to reduce torque and ripple noise. To allow more room for error, the width of each tooth 16 can be changed. Finally, there are no end turn losses and with the flux not reversing direction there is ½ hysteresis loss.

Additionally, the stacks can be separated onto independent shafts and linked with a gear or timing belt. The invention can use additional stacks, phases to increase torque and further reduce ripple and cogging torques.

The number of stator and rotor teeth can be of any number. This impacts the degrees of stacked relation offset which will be optimized to accommodate the number of teeth and phases.

The rotor and stator can be interchanged such that the winding is placed on the inner core which will be stationary and the outer core will rotate again separated by an air gap.

Control types can consist of any existing art such as sinusoidal, trapezoidal with PWM or step type operation. Additionally, the use of a capacitor to provide a phase shift for two phase operation.

What is claimed is:

1. A stacked transflux electric motor, comprising:
a rotor mounted to a rotatable shaft;
a plurality of stators in stacked relation having inwardly extending alignment teeth that enclose the rotor; and
wherein the alignment teeth of one of the plurality of stators is offset with respect to the alignment teeth of an adjacent stator of the plurality of stators.

2. The motor of claim 1 wherein the rotor has a plurality of teeth that extend outwardly from the shaft.

3. The motor of claim 2 wherein the plurality of teeth each have a plurality of u-shaped breakouts.

4. The motor of claim 1 wherein each of the plurality of stators have an outer shell, a stator core, and a stator winding.

5. The motor of claim 4 wherein each stator winding has a trapezoidal shape.

6. The motor of claim 1 wherein each of the plurality of stators has a filler material between an outer shell and an inner diameter.

7. The motor of claim 1 wherein an inner diameter of each of the plurality of stators is greater than an outer diameter of the rotor to form an air gap.

8. The motor of claim 1 wherein the alignment teeth of one of the plurality of stators is offset by 20 degrees with respect to the alignment teeth of an adjacent stator of the plurality of stators.

9. The motor of claim 1 further comprising a control that selectively activates a stator winding in one of the plurality of stators.

10. The motor of claim 1 wherein when a stator winding of one of the plurality of stators is active a flux occurs through the length of the stator.

11. The motor of claim 1 further comprising a multiple step control arrangement consistent with the number of phases.

12. The motor of claim 1 wherein current provided to stator windings in the plurality of stators flows in a single direction.
